(19) United States
(12) Patent Application Publication
(10) Pub. No.: US 2017/0158026 A1
(43) Pub. Date: Jun. 8, 2017

(54) TRANSPORT REFRIGERATION UNIT AND METHOD OF DRIVING A COMPRESSOR

(71) Applicant: Carrier Corporation, Farmington, CT (US)

(72) Inventors: Cyril Menard, Hauville (FR); Ludovic Lanuzel, Bonsecours (FR)

(21) Appl. No.: 15/325,554

(22) PCT Filed: Jul. 15, 2014
(86) PCT No.: PCT/IB2014/001447

§ 371 Date: Jan. 11, 2017

(51) Int. Cl. B60H 1/32

(52) U.S. Cl. CPC B60H 1/3222; B60H 1/3232; B60H 1/3226; B60H 2001/3294

(57) ABSTRACT

A transport refrigeration unit includes, a compressor, a coupling in operable communication with the compressor, and an engine in operable communication with the coupling, the engine is mountingly receptive to an electric motor such that when the electric motor is mounted to the engine the electric motor is in operable communication with the coupling, the coupling is configured to be driven by whichever of the engine and the electric motor is running.

### BACKGROUND

Transport refrigeration units are often used to maintain a desired climate of perishable goods while they are being transported. Units that are designed to be mounted and used on a vehicle while the vehicle is on the road typically employ an engine that runs on hydrocarbon fuels such as gasoline or diesel fuel, for example. These engines drive a refrigerant compressor of the unit. Some such units are also equipped with electric motors to drive the refrigerant compressor instead of the engine during stand-by (when the vehicle is not on the road). Although such units serve the purpose for which they were designed the industry is always receptive to systems and methods that advance the state of the art.

### BRIEF DESCRIPTION

Disclosed herein is a transport refrigeration unit. The unit includes, a compressor, a coupling in operable communication with the compressor, and an engine in operable communication with the coupling, the engine is mountingly receptive to an electric motor such that when the electric motor is mounted to the engine the electric motor is in operable communication with the coupling, the coupling is configured to be driven by whichever of the engine and the electric motor is running.

Further disclosed herein is a method of driving a compressor. The method includes, driving a coupler coaxially aligned with an engine and an electric motor with whichever of the engine and the electric motor is running, and rotating a shaft of a compressor with a drive link operably engaged with the coupler.

### BRIEF DESCRIPTION OF THE DRAWINGS

The following descriptions should not be considered limiting in any way. With reference to the accompanying drawings, like elements are numbered alike:

FIG. 1 depicts a schematic view of a transport refrigeration unit disclosed herein;

FIG. 2 depicts a perspective view of a transport refrigeration unit disclosed herein;

FIG. 3 depicts an alternate perspective view of the transport refrigeration unit of FIG. 2;

FIG. 4 depicts a perspective view of a transport refrigeration unit disclosed herein that includes a frame; and

FIG. 5 depicts the frame of the transport refrigeration unit in FIG. 4.

### DETAILED DESCRIPTION

A detailed description of one or more embodiments of the disclosed apparatus and method are presented herein by way of exemplification and not limitation with reference to the Figures.

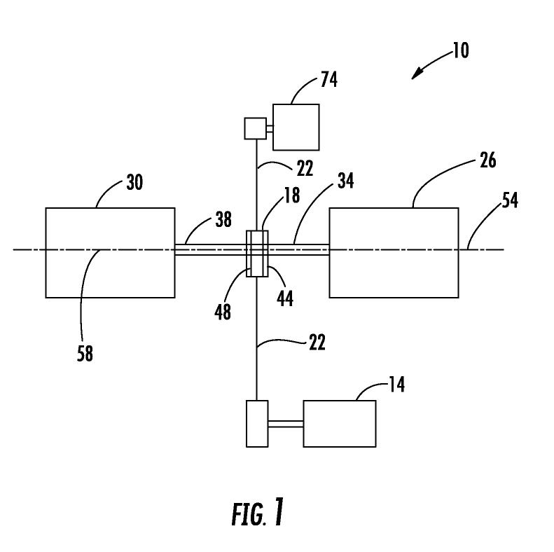

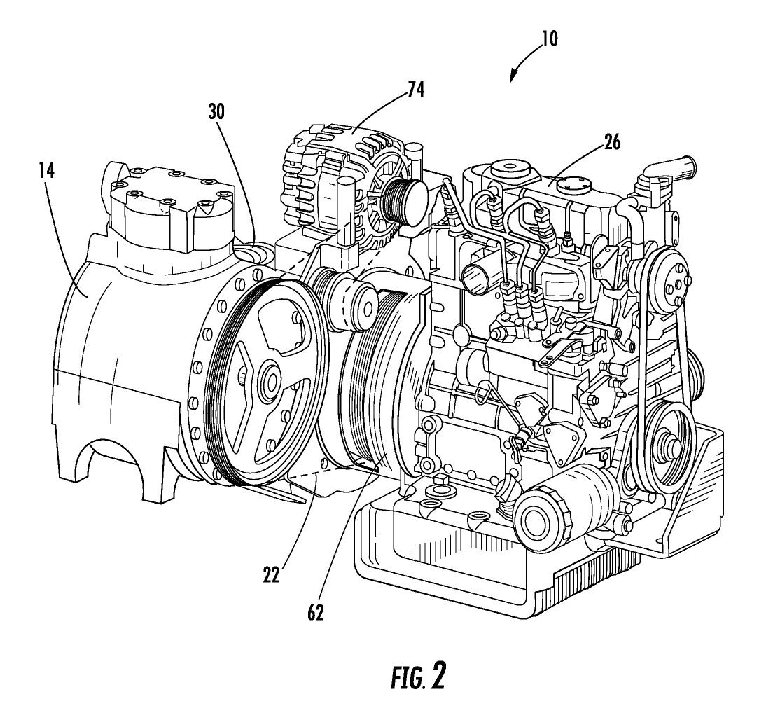

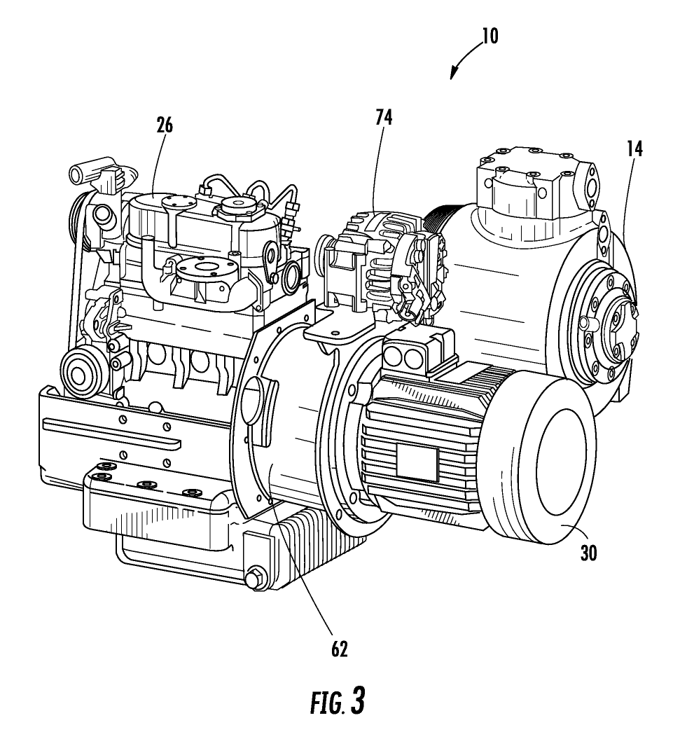

Referring to FIGS. 1-3 an embodiment of a transport refrigeration unit disclosed herein is illustrated at 10. The transport refrigeration unit 10 includes a compressor 14 and a coupling 18 operably engaged to the compressor 14 by a drive link 22 illustrated herein as a single belt (the routing of which is represented by dashed lines in FIG. 2), although chains, bands and other mechanisms are contemplated. An engine 26 and an electric motor 30 are also operably engaged to the coupling 18 in a manner such the coupling 18 is rotationally driven by whichever of the engine 26 and the electric motor 30 is running. Stated another way, a shaft 34 of the engine 26 and a shaft 38 of the electric motor 30 are both operably engaged to the coupling 18 such that the coupling 18 can rotate while either of the shafts 34, 38 does not, but neither of the shafts 34, 38 can rotate without causing the coupling 18 to also rotate. This allows the engine 26 and the electric motor 30 to become idle or not rotating when not running even while the other and the coupling 18 are rotating. To achieve this result, in one embodiment, a first one-way clutch 44 is engaged between the shaft 34 and the coupling 18 and second one-way clutch 48 is engaged between the shaft 38 and the coupling 18.

In one embodiment the coupling 18 is positioned coaxially with both a rotational axis 54 of the engine 26 and a rotational axis 58 of the electric motor 30. In this embodiment the coupling 18 is positioned between the engine 26 and the electric motor 30. The engine 26 and the electric motor 30 can be structurally attached together directly or via a housing 62 that is attachable to both the engine 26 and the electric motor 30 as is shown in one illustrated embodiment. With the forgoing structure the transport refrigeration unit 10 can be built with just one or the other of the engine 26 and the electric motor 30 and function just fine. In embodiments employing both the engine 26 and the electric motor 30 the unit 10 can be operated via either the engine 26, such as while a truck to which the unit 10 is attached is on the road, or via the electric motor 30 while the truck is parked and electric power is supplied to the electric motor 30 such as via plugging into the electrical grid, for example.

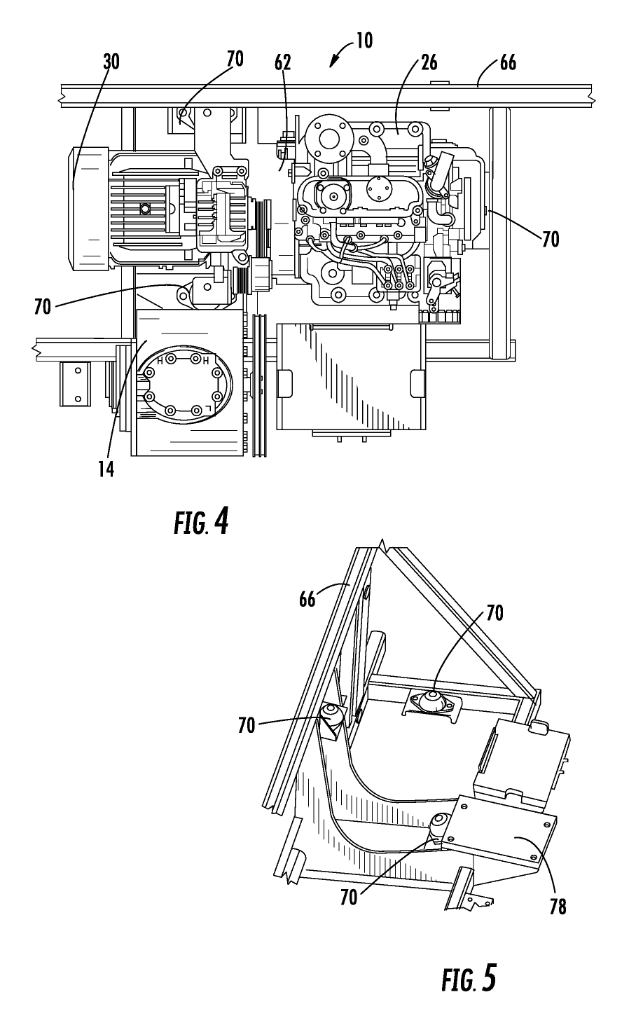

Referring to FIGS. 4 and 5 the transport refrigeration unit 10 optionally includes a frame 66. The frame 66 allows the unit 10 to be easily handled and moved including while shipping the unit 10 and while attaching the unit 10 to a vehicle. The frame 66 also permits vibration or shock isolation mounts 70 to be engineered and positioned at specific locations to reduce transmission of vibration and noise from the engine 26 and the electric motor 30, for example, to the frame 66. For example, the mounts 70 may be made of specific materials, and have specific durometers and geometries to specifically target isolation of vibrational frequencies and magnitudes at the specific locations where they are employed. These locations may include vibrational nodes (points along a standing wave where the wave has minimal amplitude), for example. With the low vibrational input to the frame 66, the frame 66 can be attached directly to a vehicle without needing additional analysis regarding vibrational transmission from the frame 66 to the vehicle to isolate vibrational input to the vehicle from the unit 10.

In one embodiment, as illustrated, the engine 26 is attached to the frame 66 by three of the mounts 70. None of the three mounts 70 attach to the electric motor 30 directly. As such, the electric motor 30 can employed in the unit 10 or alternatively can be left off of the assembly (for road only applications where there is not a need for the electric motor 30) without having to alter how the engine 26 is attached to the frame 66 or how the frame 66 is attached to a vehicle. Similarly, in one embodiment a generator 74 (sometimes also referred to as an alternator) is attached to the engine 26 directly as well. Although in the illustrated embodiment the compressor 14 is mounted to the frame 66 via a bracket 78, it should be appreciated that the compressor 14 could also be attached to the engine 26 directly as well, or to the housing 62 that is attached to the engine 26.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A transport refrigeration unit comprising:
a compressor;
a coupling in operable communication with the compressor; and
an engine in operable communication with the coupling, the engine being mountingly receptive to an electric motor such that when the electric motor is mounted to the engine the electric motor is in operable communication with the coupling, the coupling being configured to be driven by whichever of the engine and the electric motor is running.

2. The transport refrigeration unit of claim 1, wherein the coupling includes at least one one-way clutch in operable communication with a shaft driven by at least one of the engine and the electric motor.

3. The transport refrigeration unit of claim 2, wherein the at least one one-way clutch is two one-way clutches and the first of the two one-way clutches is in operable communication with the engine and the second of the two one-way clutches is in operable communication with the electric motor.

4. The transport refrigeration unit of claim 1, wherein a rotational axis of the engine is substantially coaxially aligned with a rotational axis of the electric motor.

5. The transport refrigeration unit of claim 1, wherein a rotational axis of the engine is substantially coaxially aligned with a rotational axis of the coupling.

6. The transport refrigeration unit of claim 1, wherein a drive link operably engages the coupling to the compressor.

7. The transport refrigeration unit of claim 6, wherein the drive link is at least one of a belt, a band and a chain.

8. The transport refrigeration unit of claim 6, wherein the drive link is a single belt.

9. The transport refrigeration unit of claim 1, further comprising a generator in operable communication with the coupling.

10. The transport refrigeration unit of claim 1, further comprising a frame, the engine being vibration isolatingly mounted to the frame.

11. The transport refrigeration unit of claim 10, wherein the compressor is mounted to the frame.

12. The transport refrigeration unit of claim 1, wherein the engine includes a housing to which the electric motor is mountable.

13. A method of driving a compressor, comprising:
driving a coupler coaxially aligned with an engine and an electric motor with whichever of the engine and the electric motor is running; and
rotating a shaft of a compressor with a drive link operably engaged with the coupler.

14. The method of driving a compressor of claim 13, further comprising idling a shaft of whichever of the engine and the electric motor is not running.

15. The method of driving a compressor of claim 13, further comprising rotating a shaft of a generator with a drive link operably engaged with the coupler.
